(19) United States
(12) Patent Application Publication
(10) Pub. No.: US 2026/0344683 A1
(43) Pub. Date: Nov. 5, 2026

(54) Random Strand Vegetable Snack Product

(71) Applicant: Frito-Lay North America, Inc., Plano, TX (US)

(72) Inventors: Kimberly Krenek Hauser, Plano, TX (US); Adrian Sanchez, Plano, TX (US)

(21) Appl. No.: 19/194,936

(22) Filed: Apr. 30, 2025

(51) Int. Cl. A21D 2/36; A21D 2/18; A21D 8/02

(52) U.S. Cl. CPC A21D 2/366; A21D 2/186; A21D 8/02

(57) ABSTRACT

A snack product having a top surface, a bottom surface, and a non-uniform peripheral surface connecting the top and bottom surface wherein at least one of the top surface or the bottom surface has a plurality of randomly oriented strands such that at least one of the plurality of randomly oriented strands connects to or passes through another of the plurality of randomly oriented strands.

Methods of making a vegetable snack product, a dough for forming the vegetable snack product, and a vegetable snack product are described. Uniquely, the snack product has at least one major surface that provides a number of randomly oriented strands that connect with other randomly oriented strands that may evoke a visual impression of hash browns.

### BACKGROUND

Increasingly, consumers seek snack products that provide a variety of tastes and textures and that have an interesting or attractive appearance with a unique, crispy texture. To that end, the inventors have created random strand vegetable snack products and, in particular an embossed random strand vegetable snack product.

### SUMMARY

The following disclosure describes a dry mix used to formulate the random strand vegetable containing snack product (may also be referred to as the snack product or vegetable snack product), a dough formed using the dry mix that is further processed to form the snack product, the resulting snack product, and methods of making each.

In general, suitable random strand vegetable snack products may be made from a dry mix that includes about 10% or more of a vegetable substrate, about 5% to about 25% of a pregelatinized starch, and one or more additives present in an aggregate amount between about 0.5% to about 5%. In some instances, the dry mix may include a cereal or grain flour or a cheese product.

Depending on the vegetable substrate, the dry mix may contain between about 10% to about 90% of a total amount of vegetable substrate (as a single vegetable substrate or as two or more vegetable substrates) with the balance being the pregelatinized starch, and/or the cereal flour and/or grain flour and/or cheese product and optionally, a minor amount of additives. The vegetable substrate may be from any suitable vegetable although in some instances, the vegetable substrate does not include fresh or individually quick frozen vegetables. Instead, the vegetable substrate may be provided in any suitable dry form such as flour, granules, flakes, clusters, powder or any combination of such dry forms. In one embodiment the vegetable substrate is provided as flakes. Suitable vegetable substrates include chickpea, green pea, yellow pea, potato (white, russet, red, yellow, blue/purple, fingerling, petite, etc.), corn, sweet potato, beets, lentil, lupin, carrot, peppers (green, yellow, red, etc.), beans (e.g., green beans, yellow beans, lima beans, etc.), broccoli, tomato (although it is technically a fruit), celery, spinach, zucchini, cucumber, cauliflower, onion, scallion, asparagus, etc. In one embodiment the vegetable substrate is potato.

The pregelatinized starch may be any suitable pregelatinized starch, although typically it will be obtained from corn, potato, and/or rice. It is thought that the use of pregelatinized starch may be effective to achieve the desired texture and dough cohesiveness to enable the described processing of the dough into the described snack product. It is contemplated that the described dry mix, dough, and resulting snack product are free of native starch and/or ungelatinized starch.

The additives may include, but are not limited to, processing aids such as leavening agents, enzymes, emulsifiers such as soy and/or sunflower lecithin, as well as seasonings like onion, garlic, parsley, and bouillon, malt, nuts, cocoa, and the like, which are typically provided in a dried or powdered form. It is also contemplated that the additives may include vitamins, minerals, and colorants, at effective levels. In addition, the additives may include ingredients such as sucrose, fructose, lactose, dextrose, and honey, polydextrose, dietary fiber, flavorants such as fruit flavoring, acidulants such as citric acid and lactic acid, preservatives such as TBHQ, antioxidants such as tocopherol and BHT, food colorants and the like. It is also contemplated the dry mix, dough, and resulting product may be free of one or more of such additives and as such, it is to be understood that the above-described one or more and other additives may be excluded from the dry mix, dough, and resulting product.

The cereal flour and/or grain flour, when present, may be present in the dry mix in amounts between about 1% to about 10% and may be selected from one or more of wheat, corn, oats, rice, rye, barley, millet, triticale, and sorghum.

The cheese product, when present, may be any suitable flavor or type of cheese depending on the desired organoleptic properties. Suitable examples include, but are not limited to white or yellow cheddar, American, asiago, blue, brie, feta, goat, gouda, Monterey jack, mozzarella, parmesan, pepper jack, Romano, Swiss, and cheese blends. The cheese product may be provided in any suitable form, e.g., fresh or powdered. When present, the cheese product may be provided in amounts between about 1% to about 4% based on the dry mix.

The dry mix may be hydrated with moisture to form a dough containing from about 25% to about 55% moisture. In this regard, each of the dry ingredients may be blended together to form a dry mix which may subsequently be hydrated and thereafter mixed to form the dough. Alternatively, each of the dry ingredients comprising the dry mix may be individually added to the water and thereafter mixed to form the dough.

The dough may be formed by mixing in any suitable manner. In one instance, the dough may be mixed in a batch manner using a batch mixer of a known type and after the dough is mixed it may be outputted from the mixer to a hopper that may feed, by gravity, the sheeting (gauge) rollers to form a sheet to a desired thickness. Alternatively, the dough may be formed by using an extruder to form a mixed dough that passes through a die slot to form a rectangular sheet. In yet another alternative, the dough may be formed by using a continuous mixer having one or more internal screws with one or more inlets to receive the dry mix and liquid. The output may pass through a die slot to form a rectangular sheet. Alternatively, the output, like the batch mixer may be feed to a hopper that may feed, by gravity, the sheeting (gauge) rollers to form a sheet to a desired thickness.

The dough is then sheeted by passing through one or more gauge roll pairs, each pair of which may be vertically oriented one above the other to reduce the thickness of the sheet to its desired thickness.

Thereafter, the sheet is passed through an embossing station in which, in one instance, an embossing roll, i.e., a roll having on its outer peripheral surface an embossing pattern, is vertically oriented above a flat roll, i.e., a roll having a smooth face, to imprint a random, strand pattern on the dough sheet. After the pattern is embossed or imprinted onto one surface of the dough sheet, the embossed or imprinted dough sheet passes through a cutting station, which cuts the embossed or imprinted dough sheet to form individual pieces. In one embodiment, the cutting station includes a first or cutting roll having on its outer peripheral a cutting pattern that is vertically oriented above a flat roll, i.e., a roll having a smooth face, to cut the embossed or imprinted dough sheet into individual pieces.

In one embodiment, the cutting roll has more than a single edge cutting pattern and, in some instances has one, two, three, four, five, six, seven, eight, or nine edge cutting patterns, which creates individual pieces having a variety of edge configurations, while the individual pieces have generally the same number of sides, i.e., three, four, five, six, seven, eight, or nine sides.

After the individual pieces have been created, they are dehydrated such as by drying, heating by one or more of convection and radiant heat, baking, toasting, and frying to produce the snack product, which will have a moisture content between about 1% to about 5% based on the weight of the snack product. The snack product may have a shelf stable relative humidity or “water activity” of less than about 0.7, or less than about 0.6, or less than about 0.5 and may have a shelf stability of at least about 2 months or at least about 6 months, when stored in proper, sealed packaging.

The snack product may then be seasoned in any known manner such as by application of an oil to the surface of the snack product and subsequent application of one or more seasonings to the oil coated surfaces to form a seasoned snack product. Alternatively, the one or more seasonings may be incorporated into a liquid such as an oil that may be applied to the snack product by, for example, spraying the snack product, while the snack product moves within, for example, a tumbler. Thereafter, the snack product, whether seasoned or not, may then be packaged.

The embossed random strand vegetable snack products exhibit at least on one side a visual appearance of a strand net-like appearance (where each strand may have an effective diameter from about 0.1 mm to about 5.0 mm or from about 0.1 mm to 2.0 mm) and possess a crisp undulating texture. Generally, the described snack products are “bite sized” so that they can be easily grasped by a consumer for consumption. As such, the longest dimension of the snack product is between about 10 mm to about 80 mm and has a thickness between about 1 mm and about 30 mm.

It will be appreciated that the snack product has two major surfaces, e.g., a top and a bottom surface and a peripheral surface that connects the top and bottom surface. At least one of the top and bottom surface and, in some instances, each of the top and bottom surfaces of the snack product, includes a plurality of strands with some of the strands being connected to other strands. While the strands may have any suitable cross sectional shape, they are generally curved or cylindrical in appearance. Because of the manner of making the strands, it will be appreciated that at least one of the top and bottom surfaces and, in some instances, each of the top and bottom surfaces have a non-uniform planar appearance. In other words, not all of the strands that are visible from either the top or bottom surface lie in the same plane.

Where the embossing station includes an embossing roll opposed from a smooth roll, it will be appreciated that one surface, e.g., the top surface, will have an appearance that differs from the other surface, e.g., the bottom surface due to the random nature of the strands and the manner in which the snack product is created (i.e., by the embossing roll acting on the sheet of dough). Further, it will be appreciated that because of the configuration of the embossing roll and, in particular, the dimensional aspects of the grooves provided in the roll, i.e., the depth, length, and location of the grooves, an impression of randomness may be visually evident when viewing the embossed surface of the snack product. In addition, in some instances, the embossing roll may have one or more docking pins provided on the outer surface and about the periphery of the embossing roll. The docking pins extend outwardly from the surface of the embossing roll a greater extent than the face of the roll and to a greater extent from the embossing pattern to create holes within the snack product. As such, there may exist gaps or holes in the snack product in which there are no visible strands present such that the gaps extend from the one surface, e.g., the top surface to the other surface, e.g., the bottom surface and/or vice versa.

The peripheral surface of the snack product generally defines a multisided shape, i.e., having three, four, five, six, seven, eight, or nine sides. However, because of the random nature of the strands and the non-uniform edges of the edge cutting patterns, each side of the peripheral surface will be non-uniform, i.e., each side of the snack product will not be a straight or nearly straight line.

The resulting embossed random strand vegetable snack product in an unseasoned state (i.e., does not contain an applied seasoning such as, but not limited to a topical seasoning) may contain from about 10% to about 90% of a vegetable substrate, about 5% to about 25% of a pregelatinized starch, and one or more additives present in an aggregate amount between about 0.5% to about 5%. In some instances, the snack product may be formed from a dry mix that includes a cereal or grain flour or a cheese. Where a cereal or grain flour is present, it may be present in the snack product in an amount from about 1% to about 10%. Where a cheese is present, it may be present in the snack product in an amount from about 1% to about 50%, and in some instances from about 10% to about 30%.

It is contemplated that the resulting snack product may or may not be flavored by applying, topically or otherwise, one or more seasonings to the vegetable snack product in any known manner. When applied, the seasoning or seasonings may comprise from about 1% to about 10%, in the aggregate, of the vegetable snack product.

The random strand vegetable snack product may have a bulk density, in an unseasoned state, between about 50 g/L to about 84 g/L, or about 55 g/L to about 75 g/L. According to aspects of the described methods and products, it will be appreciated and it is contemplated that because the described snack product is formulated to have a bulk density within the range of about between about 50 g/L to about 84 g/L, it will be free of and will not contain pieces or particles of vegetable (or fruit), whether fresh, dehydrated, or present in some other form other than flours or powders.

Additionally, it is contemplated that the described dry mix, dough, and vegetable snack product may be free of exogenous fibers, proteins, and/or sugars or sweeteners. Exogenous fiber refers to fiber that is added to the dry mix or dough, i.e., added fiber, in contrast to fiber that that is naturally present in the ingredients forming the described dry mix, dough, and vegetable snack product, which is considered to be intrinsic (or endogenous) fiber. Examples of exogenous fiber may be inulin and polydextrose, which may be excluded from the described dry mix, dough, and vegetable snack product. Similarly, it is contemplated that the described dough and snack product may be free of exogenous protein. Exogenous protein refers to protein that is added to the dough, i.e., added protein, in contrast to protein that that is naturally present in ingredients forming the described dough and vegetable snack product (i.e., protein naturally or intrinsically present in, for example, chickpea flour), which is considered to be intrinsic (or endogenous) protein. An example of exogenous protein is albumin. Further, it is contemplated that in some aspects, the described dough and vegetable snack product may be free of exogenous sugar or sweetener. Exogenous sugar or sweetener refer to sugar that is added to the dough (e.g., corn syrup, sugar, cane sugar, etc.) in contrast to sugar that may be naturally present in ingredients forming the described dry mix, dough, and vegetable snack product (i.e., fructose, sucrose and glucose naturally or intrinsically present in, for example, potatoes and potato-based ingredients).

Advantageously, the described snack food products are made by methods that do not require tempering and, in some instances, the methods of making the described snack food products are made using methods in which none of the ingredients are subjected to tempering.

All percentages recited above and in the following description and claims are percent by weight unless specifically noted otherwise. Other aspects and advantages of this invention will be appreciated from the following detailed description.

### BRIEF DESCRIPTION OF THE DRAWINGS

FIG. 1 illustrates one method of preparing an embossed random strand vegetable snack product according to described embodiments.

FIG. 2 is a plan view of a portion of one embodiment of an embossing roll.

FIG. 3 is a plan view of a portion of one embodiment of a cutting pattern that may be applied to the cutting roll and it shows seven individual piece patterns, each having six sides such that non-contiguous sides differ from other non-contiguous sides.

FIG. 4 is a top plan view of a top surface of one embodiment of the described snack product.

### DETAILED DESCRIPTION OF THE INVENTION

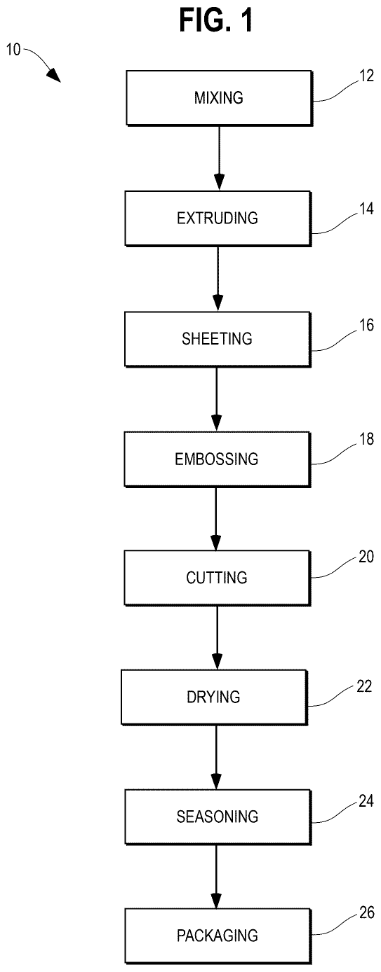

Referring to FIG. 1, an exemplary method 10 for preparing an embossed random strand vegetable snack product is shown. The method 10 includes mixing 12 a plurality of dry ingredients to provide a dry mix. The term dry ingredients is meant to refer to ingredients that have not been hydrated with exogenous moisture and yet, the dry ingredients may contain a nominal amount of inherent moisture. For example, the vegetable substrate may be provided as a dry powder or flour and as such, it is known that flours contain amount of moisture in the range of about 5% to 10%.

### Dry Mix

In general, desired snack products may be made from a dry mix that includes about 10% or more of a vegetable substrate, about 5% to about 25% of a pregelatinized starch, and one or more additives present in an aggregate amount between about 0.5% to about 5%. In some instances, the dry mix may include a cereal or grain flour or a cheese. Depending on the type of the vegetable substrate, the dry mix may contain between about 10% to about 90% of a total amount of vegetable substrate (as a single vegetable substrate or as two or more vegetable substrates) with the balance being the pregelatinized starch, the cereal or grain flour or cheese and optionally, a minor amount of additives.

The vegetable substrate may be from any suitable vegetable although in some instances, the vegetable substrate does not include fresh or individually quick frozen vegetables and it is contemplated that fresh or individually quick frozen vegetables are excluded from the dry mix, dough, and snack product. Instead, the vegetable substrate may be provided in any suitable dry form such as flour, granules, flakes, clusters, powder or any combination of such dry forms. Suitable vegetable substrates include chickpea, green pea, yellow pea, potato, corn, sweet potato, beets, lentil, lupin, carrot, peppers (green, yellow, red, etc.), beans (e.g., green beans, yellow beans, lima beans, etc.), broccoli, tomato (although it is technically a fruit), celery, spinach, zucchini, cucumber, cauliflower, onion, scallion, asparagus, etc. In one embodiment the vegetable substrate is potato and is provided as potato flour and/or potato flakes.

The vegetable substrate may be present in the dry mix in amounts of about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%. In some aspects, the vegetable substrate may be present in the dry mix in a range where the lower limit may be from any one of about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, or about 89%, while the upper limit may be from any one of about 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%.

The pregelatinized starch may be any suitable pregelatinized starch, although typically it will be obtained from corn, potato, and/or rice. It has been found that the pregelatinized starch is effective to achieve the desired texture and dough cohesiveness to enable the described processing of the dough into the described snack product. As noted, the starch is typically provided as a pregelatinized starch and to that end, it is contemplated that the described dry mix, dough, and resulting snack product are free of native starch, i.e., ungelatinized starch.

The pregelatinized starch may be present in the dry mix in an amount from about 5% to about 25%. To that end, the dry mix may include pregelatinized starch in an amount from about 5%, 6%, 7%, 8%, 9%, 10%, 11%, 12%, 13%, 14%, 15%, 16%, 17%, 18%, 19%, 20%, 21%, 22%, 23%, 24%, or about 25%. In some aspects, the pregelatinized starch may be present in the dry mix in a range where the lower limit may be from any one of about 5%, 6%, 7%, 8%, 9%, 10%, 11%, 12%, 13%, 14%, 15%, 16%, 17%, 18%, 19%, 20%, 21%, 22%, 23%, or about 24%, while the upper limit may be from any one of about 6%, 7%, 8%, 9%, 10%, 11%, 12%, 13%, 14%, 15%, 16%, 17%, 18%, 19%, 20%, 21%, 22%, 23%, 24%, or about 25%.

The additives may include processing aids such as leavening agents, enzymes, emulsifiers, oils as well as seasonings like onion, garlic, parsley, and bouillon, malt, nuts, cocoa, and the like, which are typically provided in a dried or powdered form. It is also contemplated that the additives may include vitamins, minerals, and colorants, at effective levels. In addition, the additives may include ingredients such as sucrose, fructose, lactose, dextrose, and honey, polydextrose, dietary fiber, flavorants such as fruit flavoring, acidulants such as citric acid and lactic acid, preservatives such as TBHQ, antioxidants such as tocopherol and BHT, food colorants and the like. It is also contemplated the dry mix, dough, and resulting product may be free of one or more of such additives and as such, it is to be understood that such additives may be excluded from the dry mix, dough, and resulting product.

When present, the additives may be present in the dry mix in an aggregate amount between about 0.5% to about 5%.

For example, the dry mix may include one or more emulsifiers present in amounts ranging from about 0.1% to about 2.0% or about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, or about 2.0%. In some aspects, the emulsifier may be present in the dry mix in a range where the lower limit may be from any one of about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, or about 1.9%, while the upper limit may be from any one of about 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, or about 2.0%. The emulsifier may be any suitable emulsifier such as, but not limited to, lecithin, egg, mono- and diglycerides of fatty acids or derivatives thereof and in some instances, the lecithin may be a sunflower or soy lecithin.

As another example, the dry mix may contain one or more leavening agents such as a bicarbonate, e.g., sodium bicarbonate and/or a phosphate such as mono calcium phosphate present in individual amounts ranging from about 0.1%, 0.2%, 0.3%, 0.4%, 0.5%, 0.6%, 0.7%, 0.8%, 0.9%, or about 1.0%. In some aspects, the individual leavening agent may be present in the dry mix in a range where the lower limit may be from any one of about 0.1%, 0.2%, 0.3%, 0.4%, 0.5%, 0.6%, 0.7%, 0.8%, or about 0.9%, while the upper limit may be from any one of about 0.2%, 0.3%, 0.4%, 0.5%, 0.6%, 0.7%, 0.8%, 0.9%, or about 1.0%.

As yet another example, it is contemplated that oils may be added to the dry mix, the dough, the extruder (when used), the continuous mixer (when used) in amounts from about 0.1 to about 1.5%. In that regard, oil may be added in an amount from about 0.1%, 0.2%, 0.3%, 0.4%, 0.5%, 0.6%, 0.7%, 0.8%, 0.9%, 1.0%, 1.1%, 1.2%, 1.3%, 1.4%, or about 1.5%.

In addition, it will be appreciated that the vegetable substrate may impart color to the resulting vegetable snack product. Nevertheless, it is contemplated that additional coloring may be desired. In such instances, it is desired to use natural colorants and to exclude artificial colorants. Natural colorants may include turmeric extract to provide a yellow color or annatto extract to provide a red color. Other natural colorants may be known by the skilled artisan and, as such, are contemplated for inclusion within the dry mix. Depending on the desired color of the vegetable snack product, the vegetable powder may be selected from one or more of tomato, beet (beetroot), spinach, or kale.

When colorants are included in the dry mix, they may be present individually or collectively in amounts from about 0.01% to about 1%, or from about 0.02, %, 0.03%, 0.04%, 0.05%, 0.06%, 0.07%, 0.08%, 0.09%, 0.1%, 0.2%, 0.3%, 0.4%, 0.5%, 0.6%, 0.7%, 0.8% 0.09%, 1%, 1.1%, 1.2%, 1.3%, 1.4%, 1.5%, 1.6%, 1.7%, 1.8%, 1.9%, or about 2.0%.

It is also contemplated that the additives may include ingredients such as sucrose, fructose, lactose, dextrose, and honey, polydextrose, dietary fiber, flavorants such as fruit flavoring, acidulants such as citric acid and lactic acid, preservatives such as TBHQ, antioxidants such as tocopherol and BHT, and the like. It is also contemplated the dry mix, dough, and resulting product may be free of one or more of such additives and as such, it is to be understood that such additives may be excluded from the dry mix, dough, and resulting product.

The cereal or grain flour, when present, may be selected from one or more of wheat, corn, oats, rice, rye, barley, millet, triticale, and sorghum. In one embodiment, the cereal or grain flour is a wheat flour. In addition, the cereal or grain flour, when present, may be present in the dry mix in amounts between about 1% to about 10%. To that end, the dry mix may include pregelatinized starch in an amount from about 1%, 2%, 3%, 4%, 5%, 6%, 7%, 8%, 9%, or about 10%. In some aspects, the pregelatinized starch may be present in the dry mix in a range where the lower limit may be from any one of about 1%, 2%, 3%, 4%, 5%, 6%, 7%, 8%, or about 9%, while the upper limit may be from any one of about 2%, 3%, 4%, 5%, 6%, 7%, 8%, 9%, or about 10%.

The cheese, when present, may be any suitable flavor or type of cheese depending on the desired organoleptic properties. Suitable examples include, but are not limited to white or yellow cheddar, American, asiago, blue, brie, feta, goat, gouda, Monterey jack, mozzarella, parmesan, pepper jack, Romano, Swiss, and cheese blends. The cheese may be provided in any suitable form such as fresh or powdered.

When present, the cheese may be provided in amounts between about 10% to about 30% based on the dry mix. To that end, the cheese, when present, may be present in the dry mix in amounts of about 10%, 11%, 12%, 13%, 14%, 15%, 16%, 17%, 18%, 19%, 20%, 21%, 22%, 23%, 24%, 25%, 26%, 27%, 28%, 29%, or about 30%. In some aspects, the cheese substrate may be present in the dry mix in a range where the lower limit may be from any one of about 10%, 11%, 12%, 13%, 14%, 15%, 16%, 17%, 18%, 19%, 20%, 21%, 22%, 23%, 24%, 25%, 26%, 27%, 28%, or about 29%, while the upper limit may be from any one of about 11%, 12%, 13%, 14%, 15%, 16%, 17%, 18%, 19%, 20%, 21%, 22%, 23%, 24%, 25%, 26%, 27%, 28%, 29%, or about 30%.

### Dough

After the dry mix is prepared by mixing the above ingredients, the dry mix may be hydrated by adding a sufficient amount of moisture to the dry mix to form a dough. Alternatively, the dry mix may be prepared and then added to a sufficient amount of water to form a dough. In other instances, each of the dry ingredients may be individually added to the water such that when all the dry ingredients are present a dough is be formed.

The dough may be formed by mixing in any suitable manner. In one instance, the dough may be mixed in a batch manner using a batch mixer of a known type, such as a horizontal mixer, spiral mixer, or planetary mixer. Alternatively, the dough may be formed by using an extruder to form a mixed dough that passes through a die slot to form a rectangular sheet. Any suitable type of extruder such as a single screw or double screw extruder having one or more zones may be used so long as the ingredients are intimately and uniformly mixed to provide the desired dough. In yet another alternative, a continuous mixer having one or more internal screws with one or more inlets to receive the dry mix and liquid may be used to form the dough. The output may pass through a die slot to form a rectangular sheet. Alternatively, the output, like the batch mixer, may be feed to a hopper that may feed, by gravity or otherwise, the sheeting (gauge) rollers to form a sheet to a desired thickness.

No matter the type of mixer used to form the dough, when created, the dough may have a moisture content between about 25% to about 55%. To that end, the dough may have a moisture content of about 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, or about 55%. In some aspects, the dough may have a moisture content in a range where the lower limit may be from any one of about 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, or about 54%; while the upper limit may be from any one of about 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, or about 55%. When the dough contains a moisture content that is outside of the above ranges, it is has been found that an unsuitable snack product results.

The resulting dough will contain from about 45% to 75% of the above-described dry mix, with the remaining balance being added water or moisture. In some aspects, the dough may contain dry mix in a range where the lower limit may be from any one of about 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, or about 75%, while the upper limit may be from any one of about 46%, 47%, 48%, 49%, 50%, 51%, 52%, 53%, 54%, 56%, 57%, 58%, 59%, 60%, 61%, 62%, 63%, 64%, 66%, 67%, 68%, 69%, 70%, 71%, 72%, 73%, 74%, or about 75%, or any range that can be created from these values. With these ranges and the above description of the dry mix in mind, the skilled artisan can determine the amount of each of the starch base ingredients, that may be present in the dough.

In some instances, oil may be added during the dough forming process. To this end, the oil may be added intermittently or continuously. When an extruder is used to form the dough and if the extruder has more than a single zone, it is contemplated that the oil may be added to one or more or even each zone in an intermittent or continuous manner. Likewise, when a continuous mixer is used, it is contemplated that the continuous mixer has one or more inlets, at least one of which will be suitable for inputting oil into the continuous mixer. The amount of added oil will typically be from about 0.1% to about 3%, or about 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, or about 3.0% The oil may be any oil suitable for oral human consumption.

### Sheeting

As noted above, the dough may be directed to a sheeting station 16, that may include one or more pairs of gauging rolls to modulate the thickness of the sheet to provide a dough sheet having a preselected desired thickness. In one instance, the sheeting station includes more than a single pair of gauging rolls such that the sheet thickness is modulated to provide a specified dough sheet of preselected thickness and/or sheet weight. In some instances, the preselected thickness of the dough sheet may be in the range of about 1 mm to about 30 mm from about 1, 2, 3, 4, 5, 6, 7, 8, 9, 10, 11, 12, 13, 14, 15, 16, 17, 18, 19, 20, 21, 22, 23, 24, 25, 26, 27, 28, or about 29 mm to about 2, 3, 4, 5, 6, 7, 8, 9, 10, 11, 12, 13, 14, 15, 16, 17, 18, 19, 20, 21, 22, 23, 24, 25, 26, 27, 28, 29, or about 30 mm or any range that can be created with these values. As an example, the minimum thickness of the dough sheet may be about 1, 2, 3, 4, 5, 6, 7, 8, 9, 10, 11, 12, 13, 14, 15, 16, 17, 18, 19, 20, 21, 22, 23, 24, 25, 26, 27, 28, or about 29 mm and the maximum thickness may be about 2, 3, 4, 5, 6, 7, 8, 9, 10, 11, 12, 13, 14, 15, 16, 17, 18, 19, 20, 21, 22, 23, 24, 25, 26, 27, 28, 29, or about 30 mm.

The specified sheet weight may be determined by cutting five circular pieces of the dough sheet, each with the same diameter and then weighing the five cut circular pieces. The desired weight is from about 10 to about 20 grams per five cut pieces. In this regard, it has been found that the above sheet weight in combination with the described formula of the dough allows the desired embossing of the pattern on the sheet of dough and allows the proper roll-off of the dough from the embossing roll, i.e., the dough does not stick to the embossing roll.

### Embossing

The sized sheet passes to and through an embossing station 18. The embossing station may include two opposed rolls such as an embossing roll opposed to a flat or smooth roll and, in some instances it is contemplated that the two opposed rolls are generally vertically oriented with respect to each other so that the dough sheet which may be travelling in a generally horizontal manner will pass through the two opposed rolls.

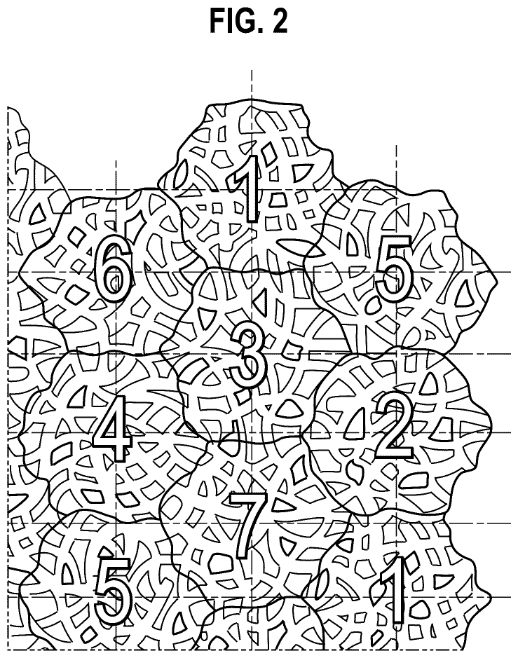

At least one of rolls, e.g., an embossing roll, has on its outer peripheral surface an embossing pattern to impart a random pattern of strands on one side of the sheet (i.e., the top or bottom of the sheet). Referring to FIG. 2, a portion of an exemplary embossing pattern that may be applied to the outer peripheral surface of the embossing roll is depicted. It will be appreciated that the embossing pattern may have a number of grooves provided into the peripheral surface of the embossing roll with each groove being provided in a non-uniform direction which may be considered to be squiggly. Additionally, grooves may be provided on the surface of the embossing roll in a manner such that some grooves have a depth greater than other grooves, which will produce, in the finished snack product, strands that extend above and below a median plane of the top and bottom surface of the snack product. In addition, it can be seen that some grooves intersect other grooves or terminate at a junction of a groove, which will cause strands in the resulting snack product to intersect other strands or terminate at a junction of a strand. With the above in mind, it will be appreciated that the direction and/or depth of any particular groove is not particularly important. Rather, it is the combination of the squiggly nature of each strand along with the differing depths of the individual grooves that will impart to the resulting snack product a visual impression on one of the surfaces of the snack product, e.g., the top surface of the snack product, of a random pattern of squiggly curved strands that may evoke an impression of hash browns.

The embossing roll may also include docking pins randomly located around their periphery. When provided, the docking pins pass through (i.e., cut through) the dough sheet such that, in the finished snack product, holes or gaps will be present, which may extend from one of the top or bottom surface of the snack product to the other of the top or bottom surface.

### Cutting

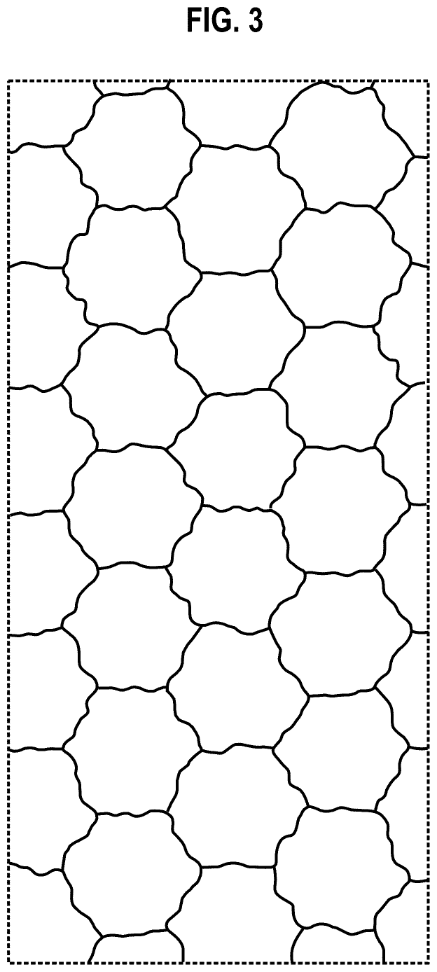

Thereafter, the embossed sheet is directed to a cutting station 20 which is separate and downstream from the embossing station 18. There, the embossed dough sheet is cut into individual pieces using a cutting roll having a plurality of edge cutting patterns, as best seen in FIG. 3. In this regard, it was found to be advantageous to provide a cutting station separate from an embossing station to achieve effective embossing and cutting, particularly as compared to a single embossing and cutting roll, i.e., a sole roll that simultaneously embosses and cuts.

In one embodiment, the cutting station may include two opposed rolls such as a cutting roll opposed to a flat or smooth roll and, in some instances it is contemplated that the two opposed rolls are generally vertically oriented with respect to each other so that the dough sheet which may be travelling in a generally horizontal manner will pass through the two opposed rolls.

In some instances, the cutting roll has more than a single edge cutting pattern and, in some instances has two, three, four, five, six, seven, eight, or nine edge cutting patterns, to create individual pieces having a variety of edge configurations, while each individual piece has the same number of sides, i.e., three, four, five, six, seven, eight, or nine sides. Referring more particularly to FIG. 3, it can be seen that, in one instance, the edge cutting pattern is such that six sided individual pieces are created, i.e., the snack product will be generally hexagonally shaped.

However, it is also evident that, in this exemplary embodiment, the provided edge cutting patterns include seven different configurations of each six sided edge cutting pattern. In other words, the configuration for an edge cutting pattern for an individual piece labelled #1, has a pattern for each side that differs from each of the other edge cutting patterns for other individual pieces, except where the sides of the edge cutting pattern labelled #1 share the same side as an adjacent edge cutting pattern.

From the above, it should be appreciated that, in view of the perceived randomness of the grooves in the embossing roll and the differing edge cutting patterns in the cutting roll, a wide variety of uniquely shaped snack products will be created.

### Drying

After creating the individual pieces, they may be dehydrated at a drying station 22 to dry the individual pieces to form the snack product having a moisture content between about 1% and about 5%. The drying may be accomplished in any known manner. In one instance, the drying may be conducted using a first and second multi-zone convective oven. The first multi-zone convective oven may heat the individual pieces at a high temperature, e.g., in a range between about 500 °F to about 700 °F for a relatively short period of time, e.g., 30 seconds to 180 seconds to reduce the moisture content in the individual pieces from about 40% to a range between about 10% to about 15%. The second multi-zone convective oven acts to further dry the individual pieces to reduce their moisture content to about 1% to about 5% by heating at a moderate temperature, e.g., 150 °F to about 300 °F for an extended period of time, e.g., from about 20 minutes to about 40 minutes.

The snack product may have a shelf stable relative humidity or “water activity” of less than about 0.7, or less than about 0.6, or less than about 0.5 and may have a shelf stability of at least about 2 months or at least about 6 months, when stored in proper, sealed packaging.

### Seasoning

Optionally, the snack product may be seasoned at a seasoning station 24 in any known manner such as by topically applying oil to the surfaces of the snack product and then adding one or more seasonings. Alternatively, the seasoning may be incorporated into a liquid such as an oil and the snack products may be seasoned by, for example, using a tumbler and spraying the oil-containing seasoning onto the snack products.

It will be appreciated that any number of seasoning or flavoring particles or compositions may be applied. By way of example without intending to limit the scope of this disclosure, the additional seasoning or flavoring, may comprise sodium chloride, table salt, kosher salt, sea salt, pepper, paprika, dill, cinnamon, sugar, cardamom, ginger, mustard, parsley, sage, thyme, ranch, barbeque, cheese, vinegar, honey, sour cream, onion, jalapeno, chile, limon, dill pickle, adobada, adovada, and any combination thereof.

In some embodiments, seasoning or flavoring may be added in minor amounts of no more than an average amount of about 10% per individual snack sized piece, depending on the type of flavor profile desired. In this regard, when the seasoning or flavoring is present on the vegetable snack product, it may be present in an amount ranging from about 1% to about 10%, or about 1%, 2%, 3%, 4%, 5%, 6%, 7%, 8%, 9%, or about 10%. In some aspects, the seasoning or flavoring may be present on the vegetable snack product in a range where the lower limit may be from any one of about 1%, 2%, 3%, 4%, 5%, 6%, 7%, 8%, 9%, while the upper limit may be from any one of about 2%, 3%, 4%, 5%, 6%, 7%, 8%, 9%, 6%, 7%, 8%, 9%, or about 10%.

Thereafter, whether the snack product has been seasoned or not, the snack product may then be packaged 26 in any known manner.

### Resulting Embossed Random Strand Vegetable Snack Product

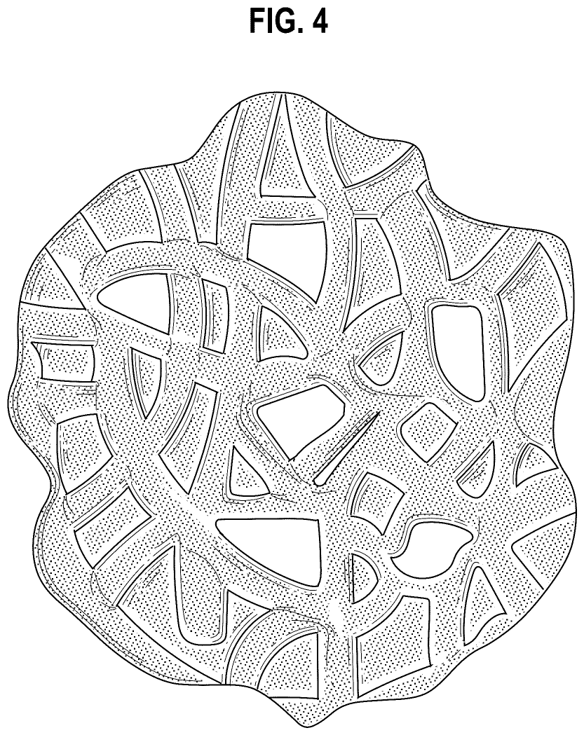

An exemplary resulting embossed random strand vegetable snack product having a generally hexagonal shape is depicted in FIG. 4. While the exemplary resulting embossed random strand vegetable snack is shown with a hexagonal shape, it should be understood that, as explained above, the resulting embossed random strand vegetable snack product, may be formed into a variety of shapes, which will be dictated by the edge cutting pattern(s) provided on the cutting roll.

It will be appreciated that the random strand vegetable snack products may exhibit a random undulating strand or squiggly strand net-like appearance. In this regard, it is evident that individual strands are visually perceptible and are randomly oriented with respect to other randomly oriented strands. In addition, visible gaps between individual and collective strands may be present and, it is possible that a visible gap completely extends from the top to the bottom of the snack and vice versa.

Generally, the described snack products are “bite sized” so that they can be easily grasped by a consumer for consumption. As such, the longest dimension of the snack product is between about 10 mm to about 80 mm and has a thickness between about 1 mm and about 30 mm, or between about 1 mm and about 20 mm.

In some instances, the longest dimension of the snack product may be from about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or about 80 mm, or any range that may be created using any of these values. In some instances, the thickness may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 mm, or any range that may be created using any of these values such as for example a ranges of about 1 mm to about 7 mm.

The random strand vegetable snack product may have a bulk density between about 50 g/L to about 84 g/L, or about 55 g/L to about 75 g/L and in some embodiments the snack product will be free of and will not contain pieces or particles of vegetable (or fruit), whether fresh, dehydrated, or present in some other form other than flours or powders.

In addition, the random strand snack product is generally formed to have two major surfaces, e.g., a top and a bottom surface and a peripheral surface that connects the top and bottom surface. At least one of the top and bottom surfaces and, in some instances, each of the top and bottom surfaces of the snack product, includes a plurality of strands with some of the strands being connected to other strands or in other instances passing through other strands, as best seen in FIG. 4. While the individual strands may have any suitable cross sectional shape, they are generally curved or cylindrical in appearance. Because of the manner of making the strands, it will be appreciated that the embossed surface will have a non-uniform planar appearance. In other words, not all of the strands that are visible from the embossed surface lie in the same plane.

It will also be appreciated that the top surface will have an appearance that differs from the bottom surface due to the random nature of the strands and the manner in which the snack product is created (i.e., by embossing roll acting on the surface of the dough sheet). Further, it will be appreciated that because of the configuration of the embossing roll pattern and, in particular, the dimensional aspects of the grooves provided in the embossing roll, i.e., the depth, length, and location of the grooves, an impression of randomness may be visually evident when viewing the embossed surface of the snack product. In addition, in some instances, the embossing roll may have one or more docking pins provided about the roll and that extend outwardly from the roll a greater extent than the face of the roll to create holes within the snack product. As such, there may exist gaps or holes in the snack product in which there are no visible strands present such that the gaps extend from the top surface to the bottom surface and/or vice versa.

The peripheral surface of the snack product generally defines a multisided shape, i.e., having three, four, five, six, seven, eight, or nine sides. However, because of the random nature of the strands and the non-uniform edges of the edge cutting patterns, each side of the peripheral surface will be non-uniform, i.e., each side of the snack product will not be a straight or nearly straight line. Accordingly, it will be appreciated that a plurality of the resulting snack products will appear to differ from each other.

### EXAMPLE

The following example provides an exemplary dry mix formulation that has been found suitable to form the resulting embossed random strand snack product when the exemplary dry mix formulation has been processed according to the method shown in FIG. 1 and described above.

### Example 1

The dry ingredients shown in Table 1 where mixed together, after which the mixture was hydrated to form a dough, that was sheeted, embossed, cut, and dried as described above.

TABLE 1

| Ingredient | Amount (wt. %) |
|---|---|
| Potato flakes | 65%-90% |
| Starch (pregelatinized corn | 5%-25% |
| starch provided as Merigel ®300, | |
| by Tate & Lyle) | |
| Leavening agent (e.g., sodium | 0.1%-1.0% |
| bicarbonate and/or monocalcium | |
| phosphate | |
| Emulsifier (e.g., powder sunflower | 0.1%-2.0% |
| deoiled sunflower lecithin | |
| Cereal or Grain Flour (e.g., | 1%-10% |
| Hard Wheat Flour) | |

In some instances, oil, e.g., a vegetable oil may be added to the dry mix at any time during the mixing of the dry ingredients, after the dry ingredients have been mixed and before the dry mix has been hydrated, or at the same time or after the dry mix is hydrated. The amount of oil that may be added may be from about 0.1% to about 1.5%.

Where an embodiment is described as comprising some element or group of elements, additional embodiments can consist essentially of or consist of the element or group of elements. Also, although the open-ended term “comprises” is generally used in this description, additional embodiments can be formed by substituting the terms “consisting essentially of” or “consisting of.”

Additionally, when a range for a particular variable is given for an embodiment, an additional embodiment can be created using a subrange or individual values that are contained within the range. Moreover, when a value, values, a range, or ranges for a particular variable are given for one or more embodiments, an additional embodiment can be created by forming a new range whose endpoints are selected from any expressly listed value, any value between expressly listed values, and any value contained in a listed range. For example, if the application were to disclose an embodiment in which a variable is 1 and a second embodiment in which the variable is 3-5, a third embodiment can be created in which the variable is 1.31-4.23. Similarly, a fourth embodiment can be created in which the variable is 1-5.

While the invention has been described in terms of specific or particular embodiments, it should be apparent that alternatives could be adopted by one skilled in the art. In addition, the invention encompasses additional or alternative embodiments in which one or more features or aspects of a particular embodiment could be eliminated or two or more features or aspects of different disclosed embodiments could be combined. Accordingly, it should be understood that the invention is not necessarily limited to any embodiment described herein or illustrated in the drawings. It should also be understood that the purpose of the above detailed description and the phraseology and terminology employed therein is to describe the illustrated embodiments, and not necessarily to serve as limitations to the scope of the invention. Finally, while the appended claims recite certain aspects believed to be associated with the invention, they do not necessarily serve as limitations to the scope of the invention.

1. A snack product having a top surface, a bottom surface, and a non-uniform peripheral surface connecting the top and bottom surface wherein at least one of the top surface or the bottom surface has a plurality of randomly oriented strands such that at least one of the plurality of randomly oriented strands connects to or passes through another of the plurality of randomly oriented strands.

2. The snack product according to claim 1 wherein the non-uniform peripheral surface defines from three to nine sides, wherein each side differs from another side.

3. The snack product according to claim 1 comprising:
from about 10% to about 90% of a vegetable substrate;
from about 5% to about 25% of a pregelatinized starch;
one or more additives in an aggregate amount from about 0.5% to about 5%; and,
from about 1% to about 5% moisture;
wherein snack product has a bulk density between about 50 g/L to about 84 g/L.

4. The snack product according to claim 3 further comprising a cereal or grain flour in an amount from about 1% to about 10%.

5. The snack product according to claim 3 wherein the vegetable substrate is selected from the group consisting of chickpea, green pea, yellow pea, potato, corn, sweet potato, beets, lentil, lupin, carrot, green peppers, yellow peppers, red peppers, green beans, yellow beans, lima beans, broccoli, tomato, celery, spinach, zucchini, cucumber, cauliflower, onion, scallion, asparagus, and mixtures thereof.

6. The snack product according to claim 3 wherein the vegetable substrate is potato.

7. The snack product according to claim 3 wherein the pregelatinized starch is selected from pregelatinized corn, potato, rice, and mixtures thereof.

8. The snack product according to claim 3 wherein the cereal or grain flour is selected from wheat, corn, oats, rice, rye, barley, millet, triticale, sorghum, and mixtures thereof.

9. A method of making an embossed random strand vegetable snack product comprising:
a. providing a dry mix that includes from about 10% to about 90% of a vegetable substrate, from about 5% to about 25% of a pregelatinized starch and one or more additives in an aggregate amount from about 0.5% to about 5%; and;
b. hydrating the dry mix;
C. mixing the hydrated dry mix to form a dough containing from 25% to 55% of moisture;
d. gauging the dough to provide a dough sheet having a preselected sheet thickness;
e. embossing at least one side of the dough sheet to create a random pattern of squiggly curved strands on the at least one side of the dough sheet;
f. cutting the sheet into individual snack-size pieces;
g. dehydrating the individual snack-size pieces;
wherein the embossed random strand vegetable snack product has a moisture content between about 1% and about 5% and a bulk density between about 50 g/L to about 84 g/L.

10. The method of claim 9 wherein the embossing is performed by directing the dough sheet past an embossing roll having on its surface a random pattern of squiggly grooves.

11. The method of claim 10, wherein the random pattern of squiggly grooves includes at least one squiggly groove having a depth that differs from another squiggly groove.

12. The method of claim 10 wherein the embossing roll includes a plurality of docking pins that puncture the dough sheet.

13. The method of claim 12 wherein the cutting is performed by directing the embossed dough sheet past a cutting roll having on its surface differing peripheral cutting edge patterns.

14. The method of claim 9 wherein the individual snack-size pieces have three, four, five, six, seven, eight, or nine sides.
